(19) United States
(12) Patent Application Publication
(10) Pub. No.: US 2007/0180368 A1
(43) Pub. Date: Aug. 2, 2007

(54) Systems and methods of data storage for a medical practice group

(76) Inventors: Philip Huber, Irvine, CA (US); Chris Stammen, Huntington Beach, CA (US); John Tangredi, Santa Ana, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/643,279

(22) Filed: Dec. 21, 2006

Related U.S. Application Data
(60) Provisional application No. 60/753,369, filed on Dec. 22, 2005.

(51) Int. Cl. G06F 17/00

(52) U.S. Cl. 715/523; 715/526

(57) ABSTRACT

Systems and methods provide a data viewer for hierarchical XML data storage of medical records for a medical practice group on transportable media. The data viewer creates a snap shot in time of a medical practice group's medical records and provides a user interface with a cross-referenced, indexed display of the medical records. The data viewer stores the data in an XML format, and then uses the XML format to provide an easy to use user interface, which is viewable on a variety of display devices using a web browser. In addition, the data viewer permits the user to access multiple patients' records rather than a single record. Furthermore, the data viewer can cause the data stored on the transportable medium to expire after a period of time. The data viewer provides physicians with a unique static database of medical records, which can be used for migration to a dynamic medical record database system.

The present application claims priority benefit under 35 U.S.C. 119(e) from U.S. Provisional Application No. 60/753,369, titled “DATA VIEWER”, filed on Dec. 22, 2005, which is hereby incorporated herein in its entirety by reference.

### BACKGROUND OF THE INVENTION

1. Field of the Invention

This invention relates to data storage and viewing, and more particularly, to the hierarchical XML data storage of medical records on transportable media.

2. Description of the Related Art

Many medical practices, such as individual physicians or medical practice groups, subscribe to providers of medical practice management systems to help manage the financial, clinical, and operational elements of successfully running a medical practice. The physicians access their patients' medical records electronically through a dynamic network interface managed by the practice management provider. Through this interface, the physicians can update their patients' medical records. Further, the patients' electronic medical records reside in a data storage device managed by the practice management provider.

When a practice terminates the subscription with the medical practice management provider, or when the medical practice management provider terminates the subscription with the practice for reasons such as, breach of payment, for example, the physician is no longer provided with the provider's medical practice management system. However, government regulations, such as the Health Insurance Portability and Accountability Act (HIPAA) regulations, require that the physicians have access to their patients' medical records.

### SUMMARY OF THE INVENTION

In an embodiment, a medical practice is provided with a data viewer comprising a static database of patient medical records associated with the practice. A medical practice can be associated with a sole medical practitioner, multiple medical practitioners, or a medical practice group comprising a group of medical practitioners. A medical practitioner can be a doctor, physician, dentist, nurse, surgeon, and the like. The data viewer provides for hierarchical XML data storage of medical records for the medical practice on transportable media. The data viewer creates a snap shot in time of the medical practice's medical records and provides a user interface with a cross-referenced, indexed display of the medical records. The data viewer stores the data in an XML format. When a user opens a patient record for viewing, the data viewer derives from the stored XML format file a new HTML document, which is displayed for the user. The document is viewable on a variety of display devices, such as, for example, computer monitors, computer displays, cell phones, personal digital assistants, IPODs, and the like, using a web browser.

In an embodiment, the data viewer permits the user to access multiple patients' records rather than a single record. In another embodiment, the data viewer causes the data stored on the transportable medium to expire after a period of time. In yet another embodiment, the static database of medical records can be used for migration to a dynamic medical record database system.

In an embodiment, a data viewer comprises a plurality of electronic patient medical records associated with a medical practice, wherein the electronic patient medical records are stored in a first format, and wherein the plurality of electronic patient medical records comprise at least two medical records from two different patients; a transform program to transform the plurality of electronic patient medical records associated with the medical practice from the first format into a second format, wherein the second format is a hierarchical XML format; and a portable storage medium configured to store the plurality of electronic patient medical records in the second format.

In another embodiment, a method of viewing medical records associated with a medical practice comprises transforming a plurality of electronic patient medical records associated with a medical practice from a first format into a second format, wherein the second format is a hierarchical XML format, and wherein the plurality of patient medical records comprise patient medical records from at least two different patients; and storing the plurality of electronic patient medical records in the second format on a portable storage medium.

In a further embodiment, a computer program resides on computer readable media and is invocable on a computer system. The computer program comprises computer code configured to transform a plurality of electronic patient medical records associated with a medical practice from a first format into a second format, wherein the second format is a hierarchical XML format, and wherein the plurality of electronic patient medical records comprise patient medical records from at least two different patients; and computer code configured to store the plurality of electronic patient medical records in the second format on a portable storage medium.

For purposes of summarizing the invention, certain aspects, advantages, and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a block diagram illustrating a dynamic medical practice management system, according to an embodiment of the invention.

FIG. 2A is a block diagram illustrating a medical records viewing system or data viewer, according to an embodiment of the invention.

FIG. 2B is a block diagram illustrating one embodiment of a data viewer configuration.

FIG. 2C is a block diagram illustrating another embodiment of a data viewer configuration.

FIG. 2D is a block diagram illustrating another embodiment of a data viewer configuration.

FIG. 3 is a flow diagram that depicts one embodiment of data viewer operations.

FIG. 4 illustrates one embodiment of a charts folder.

FIG. 5 illustrates one embodiment of a chart associated with a patient.

FIG. 6 illustrates one embodiment of a data viewer screen for displaying problems associated with the patient.

FIG. 7 illustrates one embodiment of a data viewer screen for displaying medications associated with the patient.

FIG. 8 illustrates one embodiment of a data viewer screen for displaying allergies associated with the patient.

FIG. 9 illustrates one embodiment of a data viewer screen for displaying messages associated with the patient.

FIG. 10 illustrates one embodiment of a data viewer screen for displaying an example of a message.

FIG. 11 illustrates one embodiment of a data viewer screen for displaying appointments associated with the patient.

FIG. 12 illustrates one embodiment of a data viewer screen for displaying insurance authorizations associated with the patient.

FIG. 13 illustrates one embodiment of a data viewer screen for displaying demographics associated with the patient.

FIG. 14 illustrates one embodiment of a data viewer screen for displaying referring providers associated with the patient.

FIG. 15 illustrates one embodiment of a data viewer screen for displaying insurance information associated with the patient.

FIG. 16 illustrates one embodiment of a data viewer screen for displaying guarantor information associated with the patient.

FIG. 17 illustrates one embodiment of a data viewer screen for displaying recalls associated with the patient.

FIG. 18 illustrates one embodiment of a data viewer screen for displaying a listing of links to medical chart documents associated with the patient.

FIG. 19 illustrates one embodiment of a data viewer screen for displaying unallocated amounts associated with the patient.

FIG. 20 illustrates one embodiment of a data viewer screen for displaying a ledger associated with the patient.

FIG. 21 illustrates one embodiment of a data viewer screen for displaying balances due associated with the patient.

FIG. 22 illustrates one embodiment of a data viewer screen for displaying billing notes associated with the patient.

FIG. 23 illustrates one embodiment of a data viewer screen for displaying flowsheets associated with the patient.

FIG. 24 illustrates one embodiment of a help screen used by the data viewer.

FIG. 25 is a flow diagram illustrating user operations of the data viewer, according to an embodiment of the invention.

### DETAILED DESCRIPTION OF THE PREFERRED EMBODIMENT

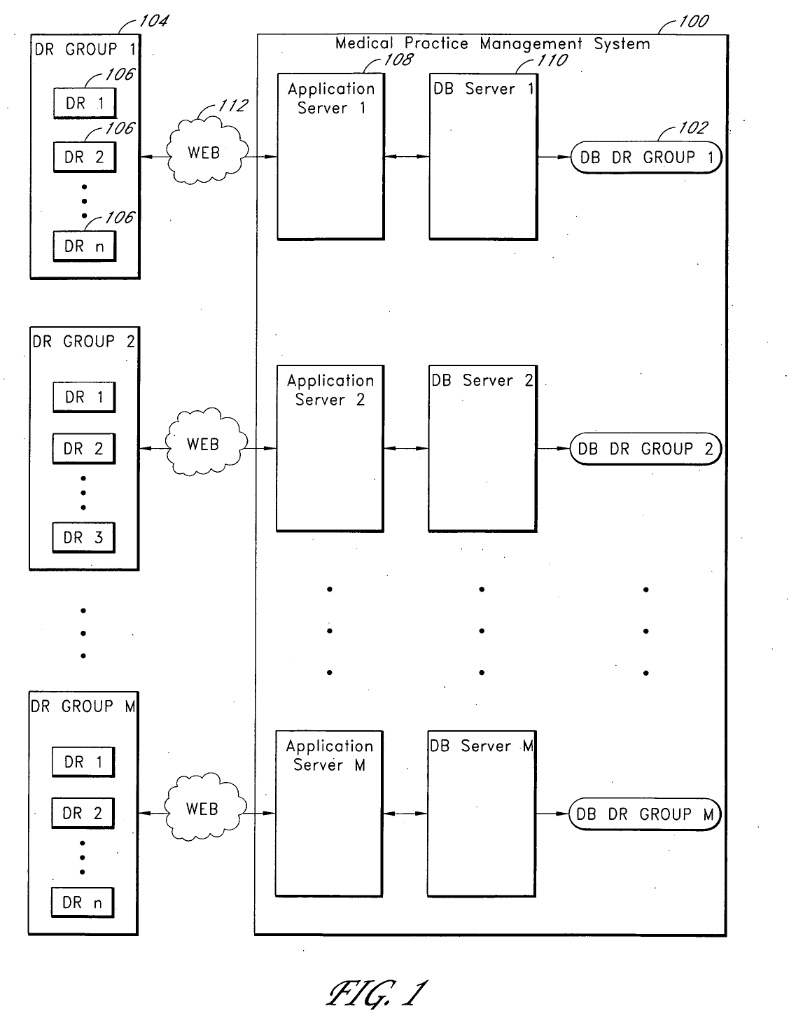

FIG. 1 illustrates an embodiment of a medical practice management system 100 comprising at least one database 102, at least one application server 108, and at least one database server 110. The application server 108 is configured to communicate with at least one database server 110 and the database server 110 is configured to communicate with at least one database 102. Each database 102 comprises patient medical records associated with the patients of a medical practice 104. The medical practice 104 comprises at least one medical practitioner computer 106, associated with at least one medical practitioner, such as a physician, doctor, dentist, nurse, and the like. The user computer 106 is configured to communicate with the application server 108 through a communications medium 112, such as the Internet.

In the embodiment illustrated in FIG. 1, the user computers 106 associated with the medical practice 104 communicate with their corresponding application server 108 and the database server 110 communicates with its corresponding database 102. In other embodiments, the application server 108 can be configured to host multiple medical practices 104 and the database server 110 can be configured to host multiple databases 102.

In an embodiment, the medical practice 104 subscribes to the medical record service provided by the medical practice management system 100. The medical practitioners using their corresponding computer 106 access their patients' medical records in their corresponding database 102. The medical practitioner can review and update the patients' medical records by reading from and writing to the database 102 associated with the medical practice 104 in the medical practice management system 100 through the servers 108, 110.

In the event that the medical practice 104 discontinues the medical record service provided by the medical practice management system 100, government regulations, in one embodiment, require the medical practice management service 100 to provide the physicians associated with the medical practice 104 with their patients' medical records. In the event that the physician leaves the subscribing medical practice 104, in another embodiment, government regulations require that the medical practice management service 100 provide the departing physician with the medical records of his patients. In yet another embodiment, physicians or medical practices 104 request from the medical practice management system 100 a backup of their patients' medical records.

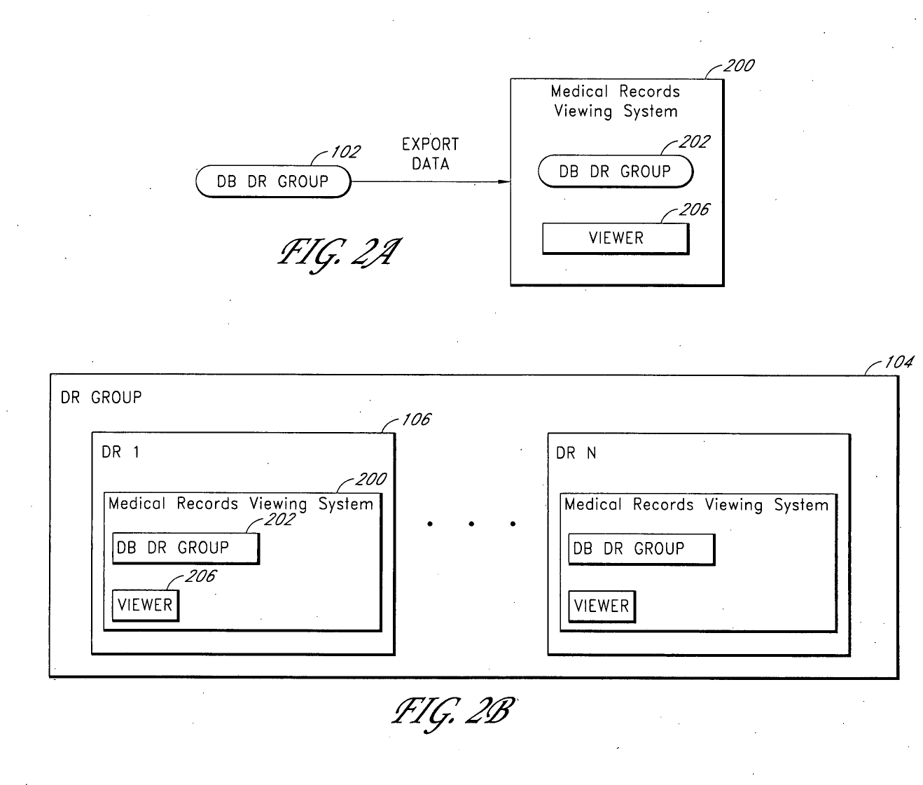

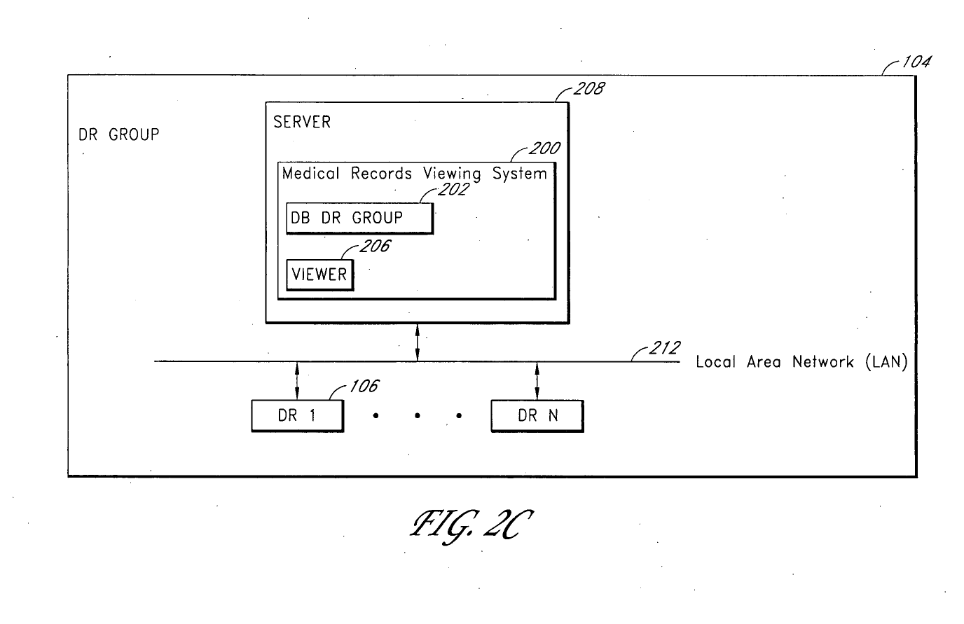

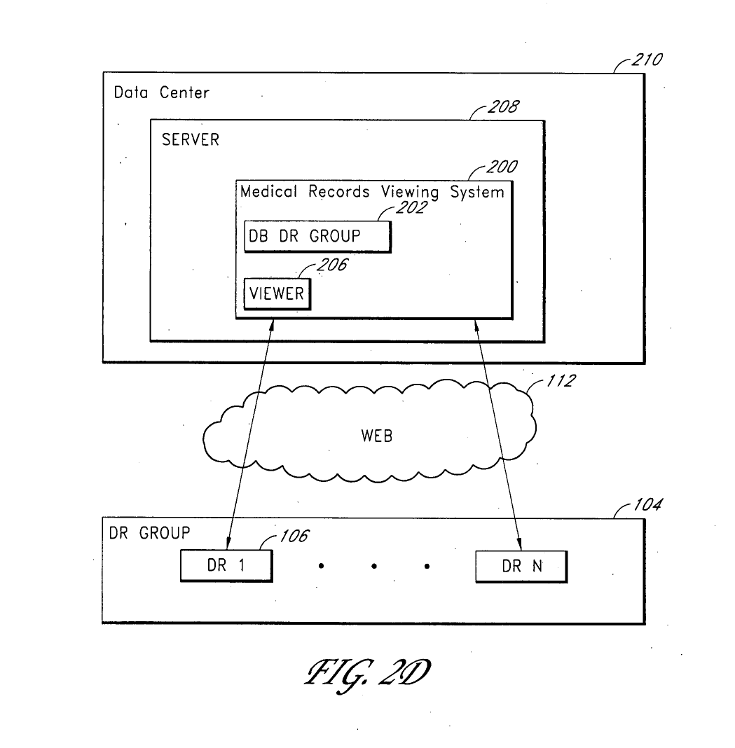

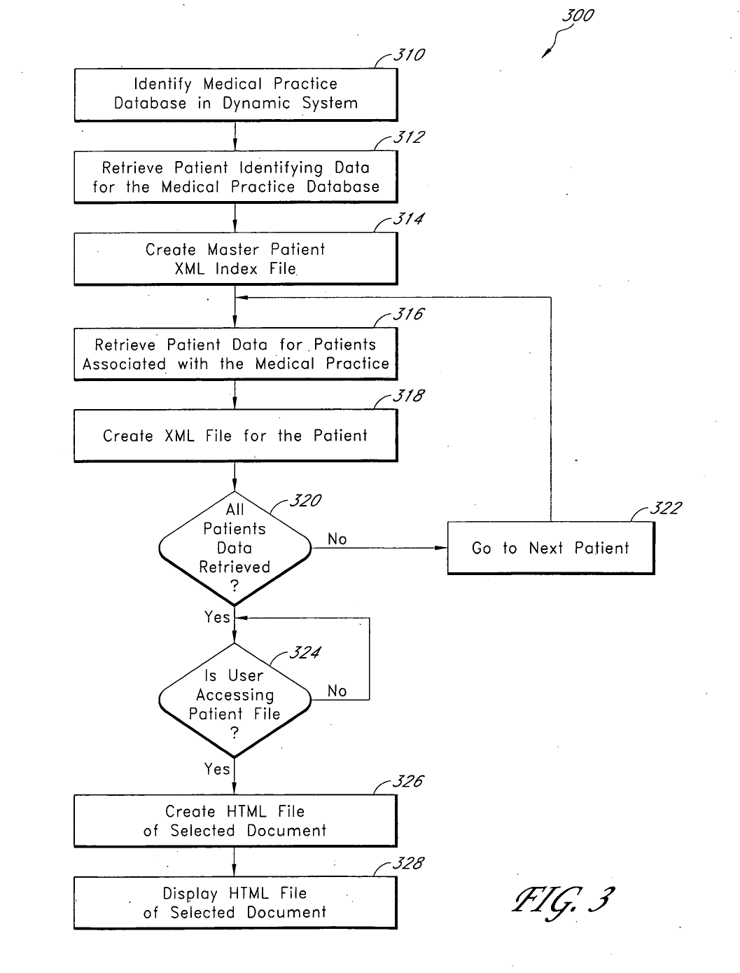

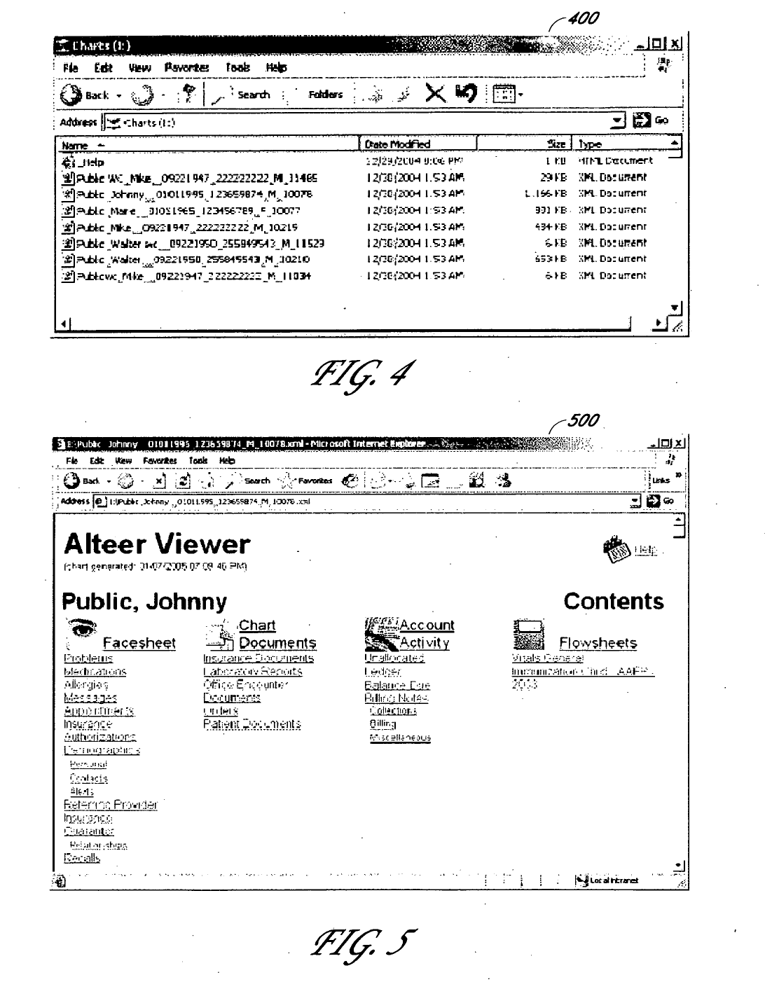

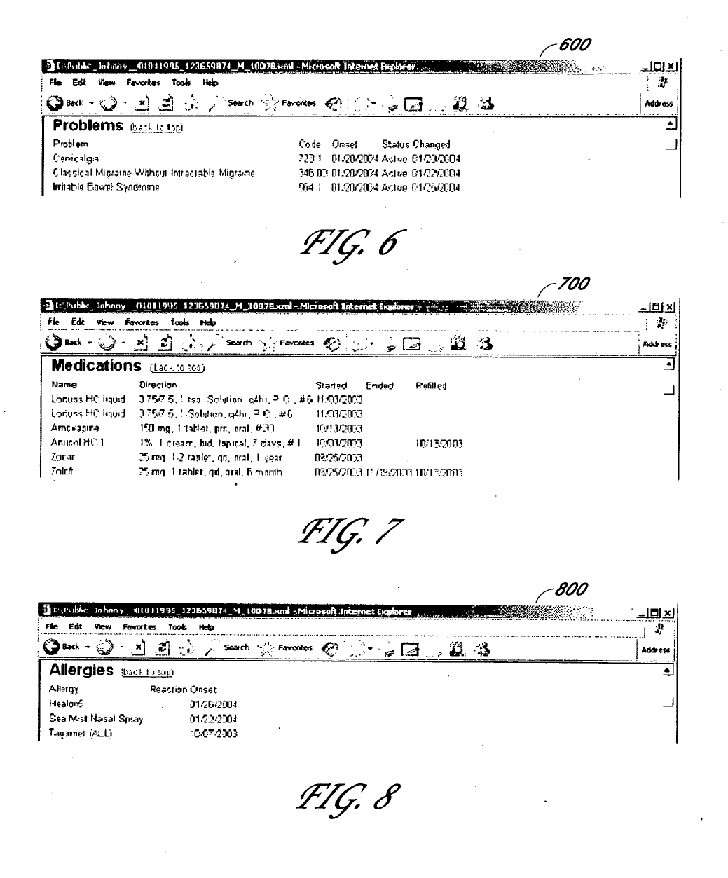

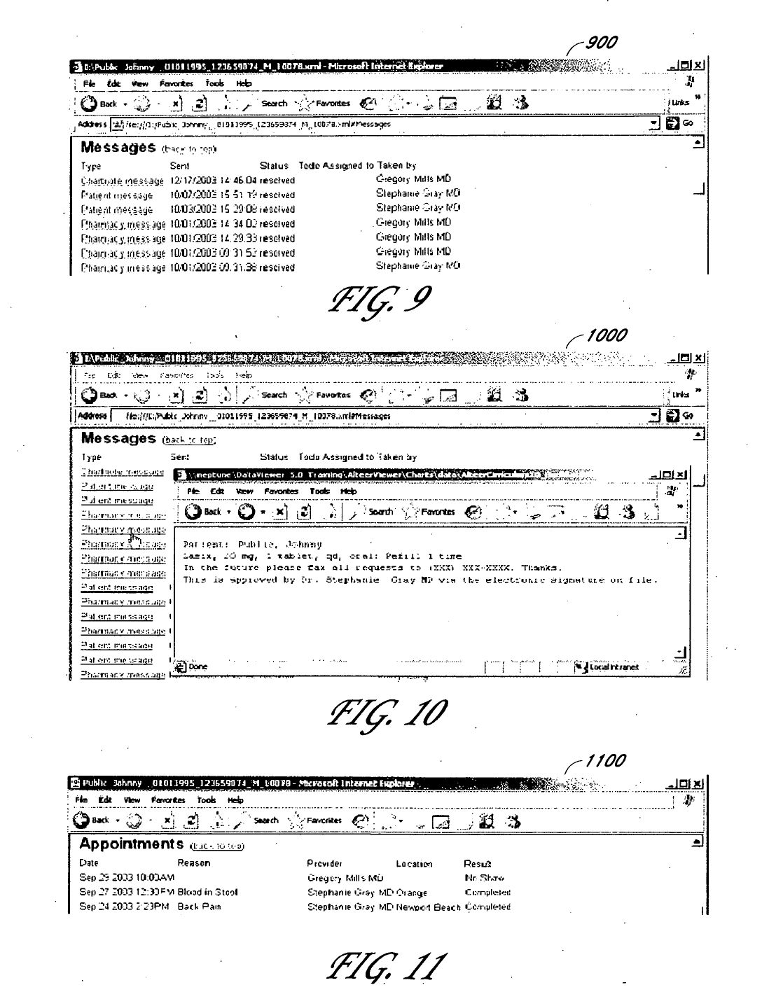

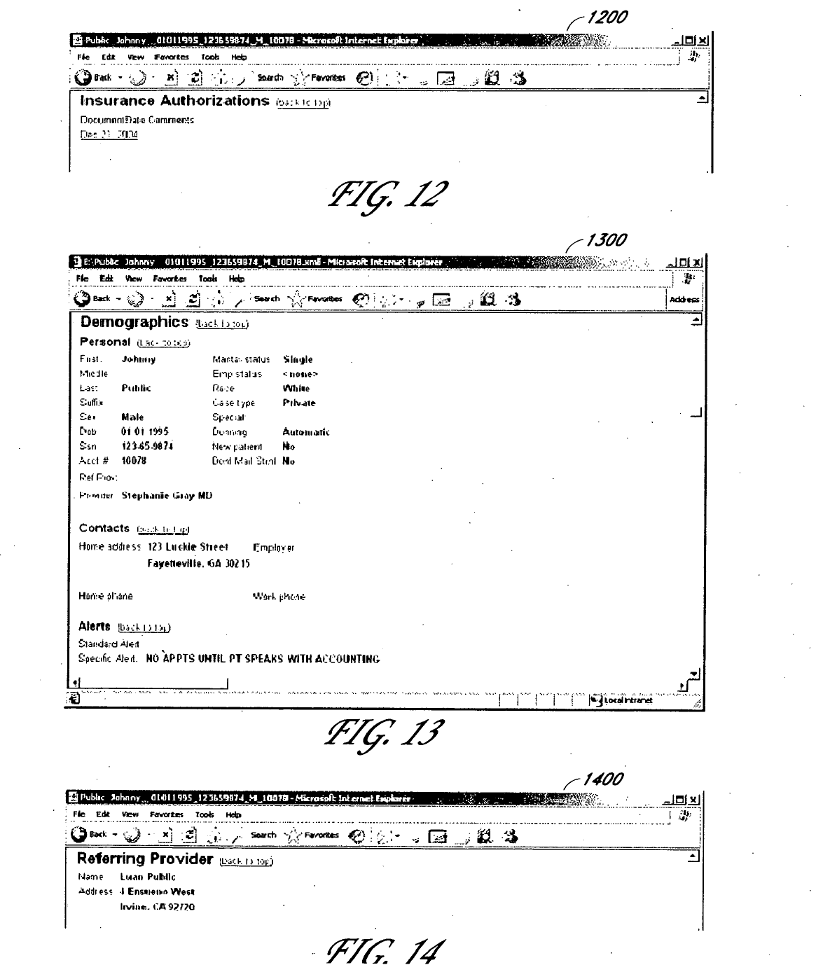

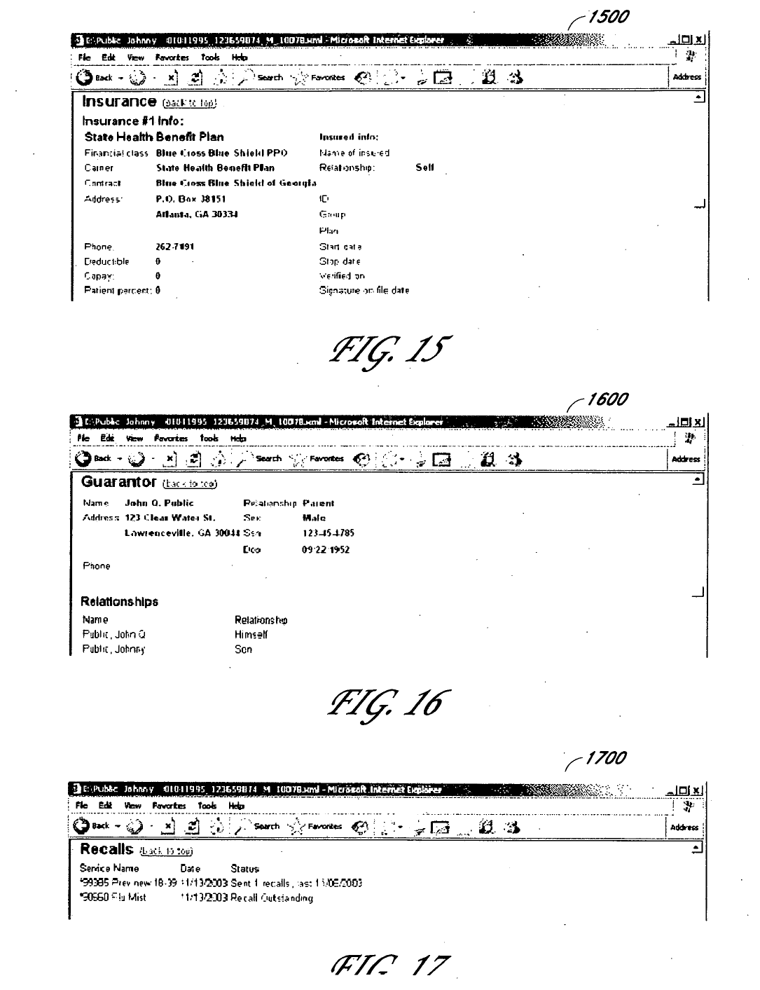

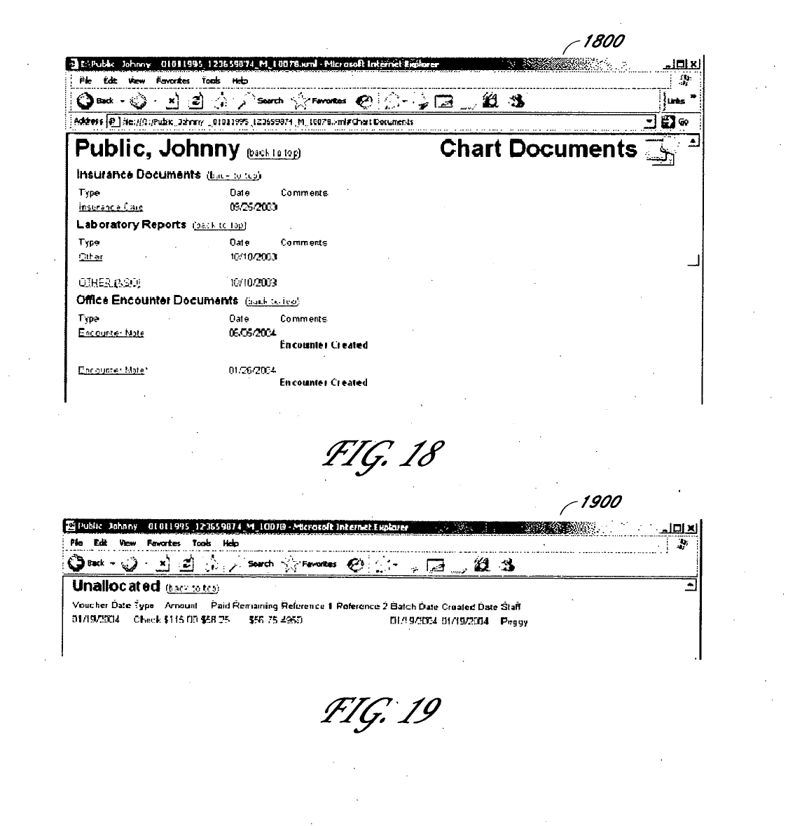

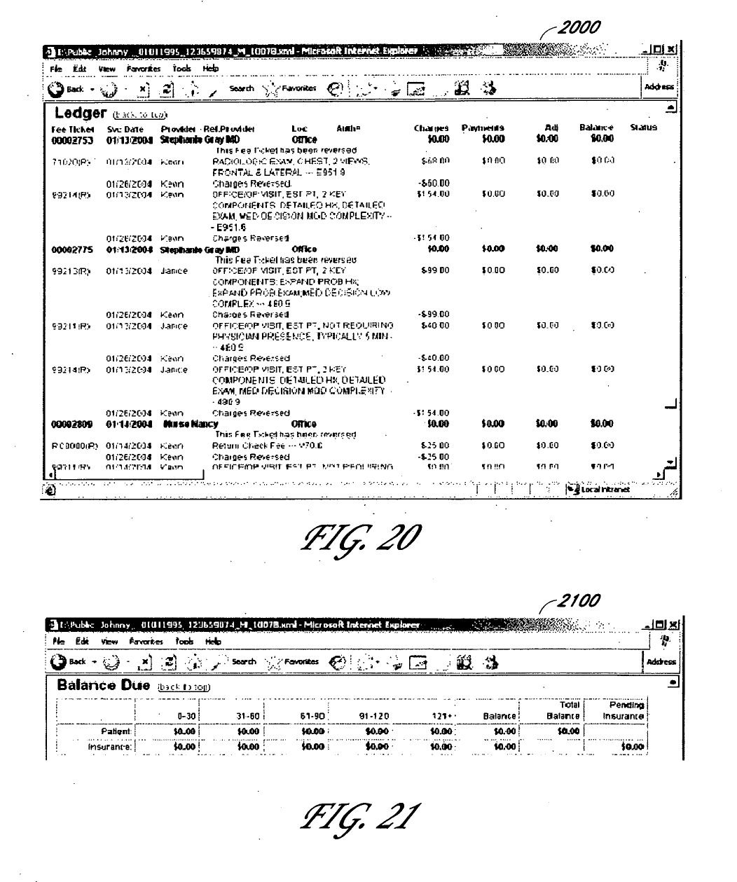

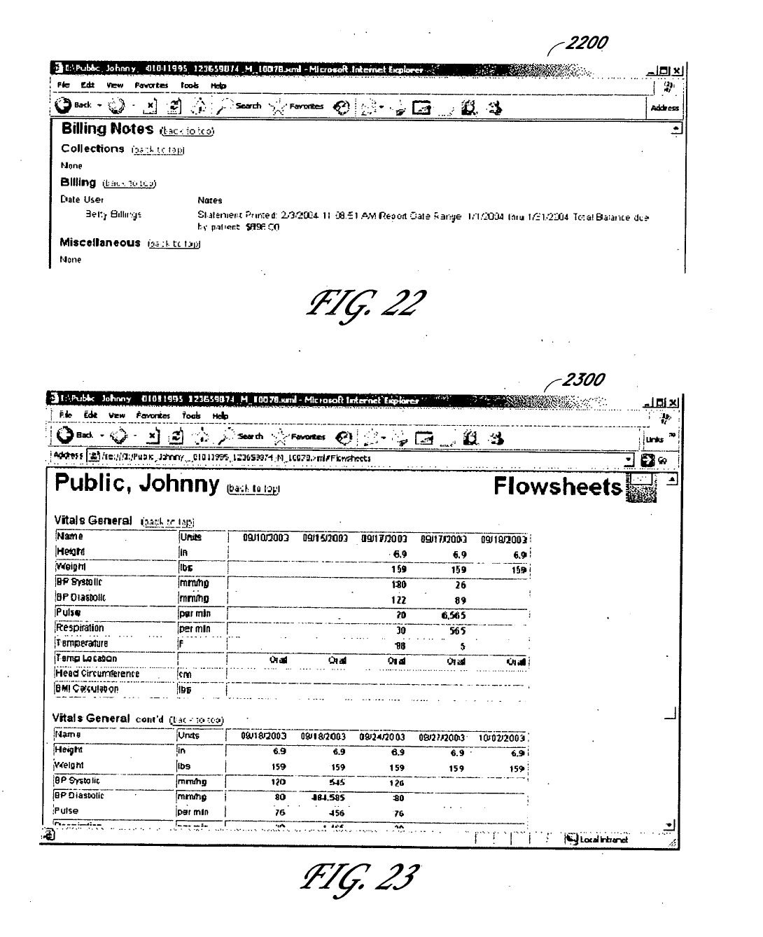

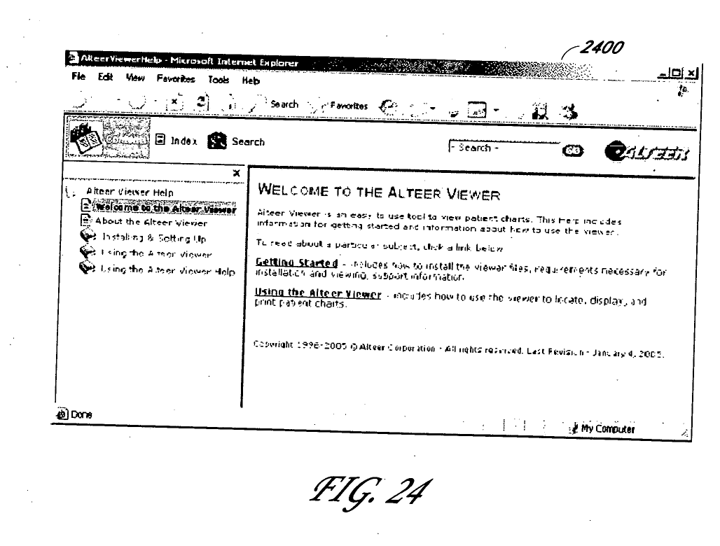

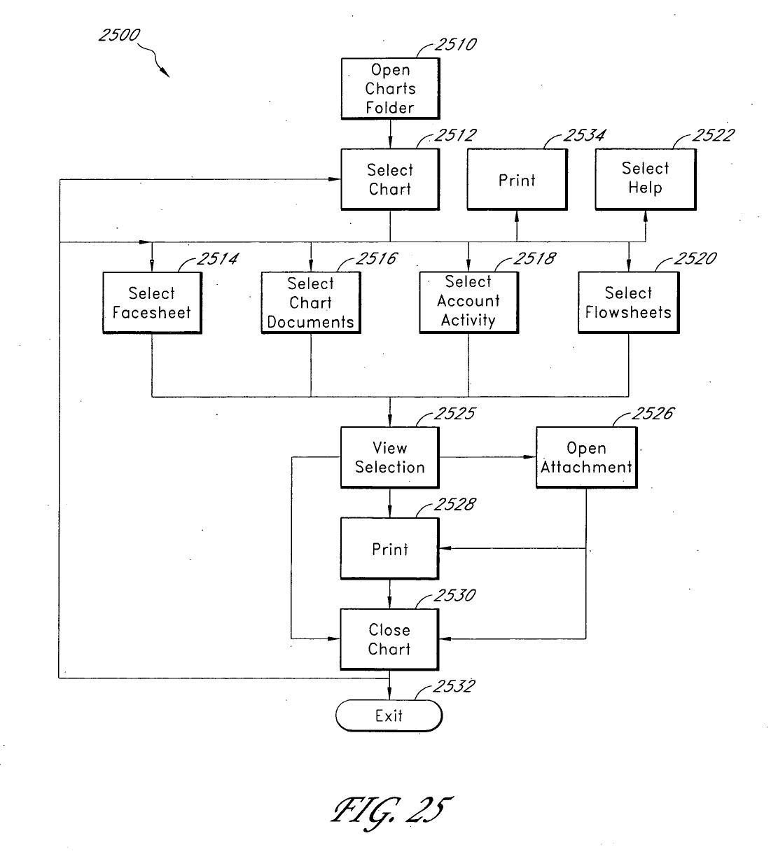

FIG. 2A illustrates a medical records viewing system or data viewer 200 that comprises a static database of patient medical records originally stored in database 102. In an embodiment, the data viewer 200 provides a back up of patients' medical records for the medical practice 104. In another embodiment, the medical practice management service 100 provides a medical practice 104 that is no longer subscribing to the service 100 with the data viewer 200 to satisfy government regulations. The data viewer 200 permits a user to locate and display patients' medical records stored in medical records database 202. In an embodiment, the medical practice 104 migrates their patient records from a first medical practice management service to a second medical practice management service using the data viewer 200.

The data viewer 200 comprises a medical practice database 202 and a data viewer program 206. FIGS. 2B, 2C, 2D illustrate various embodiments of a data viewer configuration for use by the medical practitioners in the medical practice 104. In the embodiment illustrated in FIG. 2B, the data viewer 200 is stored on a portable medium and communicates with a user computer 106 through a port. In an embodiment, the portable medium comprises a hard disc drive. In another embodiment, the portable medium comprises a USB (Universal Serial Bus) drive and the port comprises a USB port. In yet another embodiment, the portable medium comprises a DVD (Digital Versatile Disc/Digital Video Disc) drive and the port comprises a DVD port. In other embodiments, the portable medium comprises one or more floppy discs, memory sticks, flash memory cards, magnetic tape, CD's, optical discs, zip drives, or the like.

In another embodiment, the medical practice database 202 and the data viewer program 206 are posted or attached to a server on a Local Area Network (LAN). In FIG. 2C, the medical practice 104 comprises a server 208 and a local area network (LAN) 212. The server 208 comprises the data viewer 200 and each user computer 106 accesses the data viewer 200 on the server 208 through the LAN 212.

In yet another embodiment, the medical practice database 202 and the data viewer program 206 are posted or attached to a public Internet Uniform Resource Locator (URL). In the embodiment illustrated in FIG. 2D, the server 208 comprising the data viewer 200 is located at a data center 210. The medical practitioners using the user computers 106 access the data viewer 200 through the communication medium 112 via the public URL. In another embodiment, the medical practitioners access the data viewer 200 through the communication medium 112 via the public URL using any computer.

The medical practice database 202 comprises patient medical records or patient chart information associated with the medical practice 104 at a selected time. For example, in an embodiment where the medical practice 104 discontinues the dynamic medical practice management system 100 or requests a backup of its medical records database 102, the data in the database 102 is exported to the portable medium and stored in the database 202. The database 202 comprises the patient medical records or chart information in the database 102 at the time the data is exported. Thus, database 202 comprises a “snap shot in time” of the patient medical records stored in database 102.

The data viewer program 206 comprises program logic stored on the portable medium along with the medical records database 202. In one embodiment, the program logic may advantageously be implemented as one or more modules. The modules may advantageously be configured to execute on one or more processors. The modules may comprise, but are not limited to, any of the following: software or hardware components such as software object-oriented software components, class components and task components, processes methods, functions, attributes, procedures, subroutines, segments of program code, drivers, firmware, microcode, circuitry, data, databases, data structures, tables, arrays, or variables.

In an embodiment, for example, the medical practice management system 100 targets the medical practice 104 to receive the data viewer 200. FIG. 3 is a flow diagram that depicts one embodiment of a data viewer process 300. In block 310, the process 300 identifies the medical practice database 102 in the dynamic medical practice management system 100 associated with targeted medical practice 104.

In block 312, the process 300 retrieves the patient identifying data for each patient in the identified medical database 102. Examples of patient identifying data include, but are not limited to patient name, social security number, insurance number, address, and the like.

In block 314, the process 300 creates and stores a master patient XML index file comprising the patient identifying data for each patient. In an embodiment, the master patient XML index file comprises a listing of the patient identifying data in an XML (extensible markup language) file format. The process 300 stores the master patient XML index file on the portable media.

In block 316, the process 300 retrieves the patient data from the patient medical record database 102 for a patient listed in the master patient XML index file. In an embodiment, the patient data comprises patient chart information, such as, for example, facesheets, chart documents, account activity, flowsheets, and the like. Facesheets comprise patient medical data associated with the patient such as, for example, medical problems, medications, allergies, messages, appointments, insurance, authorizations, demographics, referring provider, insurance information, guarantor information, recalls, and the like. Chart documents comprise categorized documents associated with and attached to the patient chart. Account activity comprises account information associated with the patient's account with the medical practice, such as, for example, charges, payment, balance due, and the like. Flowsheets comprise charts of patient data in digital format acquired through clinical measures, and the like.

In block 318, the process 300 creates a unique XML file for the patient. Each XML file contains patient chart information and a path to each of the patient chart documents associated with the patient.

In block 320, the process 300 determines whether the patient data from the master patient XML index file has been retrieved. If the patient data has not been retrieved from the master patient XML index file, the process 300 selects the next patient in block 322. Blocks 316-322 are repeated until the patient data from the patients in the master patient XML file has been retrieved from the medical database 102 and stored in the medical database 202 as an XML file. In an embodiment, the patient data is stored in the medical database 202 as an XML file with paths to at least one chart document.

Since each practice 104 has a different set of patient data, each data viewer implementation is unique to a specific medical practice 104. In an embodiment, the data viewer 200 comprises a self-contained directory. In an embodiment, the directory structure comprises the viewer directory comprising the data viewer program 206 and the charts subdirectory comprising files, such as XML files, corresponding to each patient.

In an embodiment, the charts subdirectory further comprises a bin directory comprising programs, stored procedures, and the like, used to view the data. In an embodiment, the bin directory comprises Internet Explorer files used to transform the XML files into an HTML (Hypertext markup language) webpage. In another embodiment, the bin directory comprises stored procedures comprising Transact Structured Query Language (T-SQL) statements.

In an embodiment, the charts directory further comprises a data directory comprising the specific patient data, such as, for example, problems, medications, account activity, and the like, that is accessed when a user views the patient medical records. In an embodiment, the data files are stored in a hierarchical format. In another embodiment, the data files are stored in a hierarchical XML file format.

In an embodiment, the charts directory further comprises a help directory comprising files and folders associated with the data viewer program help system.

Once the user installs the data viewer 200 on the user computer system, the user can access and review the patient medical records in the medical database 202 using Windows Explorer and a web browser on the user computer, according to an embodiment. In an embodiment, the user computer comprises the web browser, Windows Explorer, to permit the user to access the content of the data viewer 200. In an embodiment, the data viewer 200 provides read-only access to copies of patient medical records.

Referring to FIG. 3, in block 324, the process 300 determines whether a user is accessing a patient file. If no accesses are occurring, the process 300 waits in block 324.

To access patient files using the data viewer 200, in an embodiment, the user opens Windows Explorer on the user computer and selects the data viewer charts folder. FIG. 4 illustrates one embodiment of a charts folder 400 used by the data viewer 200. The charts folder displays the chart name for each patient in the database 202. The chart name comprises data that identifies the patient. In an embodiment, the chart name comprises at least one of the patient's last name, first name, middle name, birth date, social security number, sex, account number, or the like.

When a user selects a chart name, the data viewer 200 displays a chart associated with the selected chart name. FIG. 5 illustrates one embodiment of a patient chart 500, which is described further below. Each section of the chart 500 comprises a list of patient records that the user can view. Once the user selects a patient record to view, the process 300 moves to block 326.

In block 326, the data viewer 200 creates a read-only HTML file of the selected document. In an embodiment, the data viewer 200 creates a new XML document, such as the HTML document, which is derived from the content of the XML document stored in the database 202. In another embodiment, the data viewer 200 transforms the XML document stored in the database 202 to create the HTML document.

In block 328, the data viewer 200 displays the HTML file of the selected document in the browser window. In an embodiment, Internet Explorer opens the application, executes the instructions to create the HTML document, and displays the HTML document in its browser for the user.

FIGS. 5-24 illustrate examples of screen shots that the data viewer 200 displays to a user accessing patient medical records. Referring to FIG. 5, the patient chart 500 comprises a facesheet section, a chart document section, an account activity section, and a flowsheets section, according to an embodiment of the invention. Each section comprises a subsection list of patient medical records. In an embodiment, the subsection lists can vary for each patient to reflect the information available for the particular patient. Examples of the categories in the subsection list for the facesheet section comprise problems, medications, allergies, messages, appointments, demographics, referring provider, insurance, guarantor, recalls, and the like.

FIG. 6 illustrates one embodiment of a problems screen 600 used by the data viewer 200 for problems associated with the patient. In an embodiment, the problems screen 600 comprises, for example, a list of problems associated with the patient, and the diagnosis code (ICD-9), the recorded onset date, the problem status (active or inactive), the date corresponding to the last change in status, and the like, associated with each problem.

FIG. 7 illustrates one embodiment of a medications screen 700 used by the data viewer 200 for medications associated with the patient. The medications screen 700 comprises, for example, a list of medication the patient uses, and the directions for the use of the medications, the date the medication was prescribed, the end date, the date of the last refill, and the like, associated with each medication.

FIG. 8 illustrates one embodiment of an allergies screen 800 used by the data viewer 200 for allergies associated with the patient. The allergies screen 800 comprises, for example, a list of any medications, foods, and the like, that cause allergic reactions in the patient, and a description of the reaction, the onset date of the reaction, and the like, for each allergy.

FIG. 9 illustrates one embodiment of a messages screen 900 used by the data viewer 200 for messages associated with the patient. The messages screen 900 comprises, for example, the type of message, and the date the message was sent, the status (resolved or unresolved), to whom the message was assigned if there was an action item associated with the message, the name of the person who took the message, and the like, for each message. Types of messages include, but are not limited to a pharmacy message, a chart note, a message from the patient, and the like.

FIG. 10 illustrates one embodiment of a messages screen 1000 displaying an example of a message. The messages screen 1000 in the embodiment illustrated in FIG. 10 displays an example of a pharmacy message.

FIG. 11 illustrates one embodiment of an appointments screen 1100 used by the data viewer 200 for past and future appointments associated with the patient. The appointments screen 1100 comprises the date, the reason for the appointment that was given when the appointment was scheduled, the result, such as, for example, completed, confirmed, or no show, the provider scheduled for the appointment, and the like.

FIG. 12 illustrates one embodiment of an insurance authorizations screen 1200 used by the data viewer 200 for insurance authorizations associated with the patient. The insurance authorizations screen 1200 comprises a list of insurance authorizations associated with the patient, and the date of the authorization, any comments, and the like for each authorization.

FIG. 13 illustrates one embodiment of a demographics screen 1300 used by the data viewer 200 for demographics associated with the patient. The demographics screen 1300 is separated into a personal information section, a contact information section, and an alert section. The personal information section comprises, for example, first name, middle name, last name, sex, date of birth, social security number, age, account number, referring physician, provider, marital status, employment status, race, a case type, such as private, workers compensation, personal injury, auto accident, and the like. The contact information comprises address, phone number, employer, work phone, and the like. The alerts section comprises any patient alerts on the account, and the like.

FIG. 14 illustrates one embodiment of a referring provider screen 1400 used by the data viewer 206 for identifying referring providers associated with the patient. The referring provider screen 1400 comprises, for example, the name and contact information of the patient's referring provider.

FIG. 15 illustrates one embodiment of an insurance information screen 1500 used by the data viewer 200 for insurance information associated with the patient. The insurance information screen 1500 comprises a list of the patient's insurance policies, and the name of the insurance carrier, the financial class and contract, contact information, deductible amount, co-pay amount, the percentage for which the insured is responsible, name and relationship of the insured party, insurance identification, group number, plan number, policy effective dates, and the like, for each insurance policy. In an embodiment, the insurance screen 1500 shows all insurance information ever associated with this patient.

FIG. 16 illustrates one embodiment of a guarantor information screen 1600 used by the data viewer 206 for guarantor information associated with the patient. The guarantor information screen 1600 comprises, for example, information about the guarantor, the relationship of the guarantor to the patient, and the like.

FIG. 17 illustrates one embodiment of a recalls screen 1700 used by the data viewer 206 which lists reminders of an appointment that may have been scheduled long ago, such as an annual examination, for example, notices of a provider's request for a follow-up appointment, a reminder to schedule an appointment, such as a mammogram, for example, and the like, associated with the patient. The recalls screen 1700 comprises the office service code and service name associated with the recall, the date the recall was sent, the recall status (outstanding, scheduled, etc), and the like.

As mentioned above, the patient chart 500 comprises the chart document section, as illustrated in FIG. 5. Examples of the chart document subsection list, include, but are not limited to insurance documents, laboratory reports, office encounter documents, orders, and patient documents associated with the patient.

FIG. 18 illustrates one embodiment of a chart documents screen 1800 used by the data viewer 200 for the chart documents associated with and attached to the chart 500. In the embodiment illustrated in FIG. 18, the patient has insurance documents, laboratory reports, and office encounter documents. The list of documents changes according to the documents attached to the chart 500. In an embodiment, the chart documents screen 1800 comprises the document type, which describes the document with a link to an HTML display of the actual document, and the date the document was created, comments about the history of actions performed relating to the document, such as, for example, the name of the person who routed the document, who reviewed the document, who signed off the document, the data and time the action occurred, and any additional comments entered at the time of the action, and the like, for each document.

The chart documents screen can comprise links to one or more documents in one or more categories. Documents belonging to a particular category are grouped together under a category heading. Examples of chart document categories and possible chart document types within the categories are listed below.

| Chart Document Categories | Chart Document Types |
|---|---|
| Billing documents | Claim Form; EOB (Explanation Of Benefit); Insurance |
| | Authorization; Insurance Card; Insurance Payment or Check; |
| | Insurance Waiver Form; Other Insurance |
| | Document; Super Bill |
| Cardiology Reports | Angiogram; Coumadin Adjustment Report; |
| | Echocardiogram; EKG; Event Monitor Report; Holter |
| | Monitor Report; Other Cardiology Document; Stress |
| | Test |
| Consultations | Consultation |
| Disability Documents | Disability Document |
| Emergency Room Reports | Emergency Room Report |
| Home Health Documents | Home Health Care Order; Home Health Care Plan; |
| | Home Health Medical Record Document |
| Hospital Reports | Consultation; Discharge Summary; Hospital Face- |
| | sheet; Hospital History and Physical; Operating |
| | Report; Other Hospital Document |
| Insurance Documents | Claim Form; EOB (Explanation Of Benefit); Insurance Authorization; |
| | Insurance Card; Insurance Payment or |
| | Check; Insurance Verification Form; Insurance |
| | Waiver Form; Other Insurance Document; Super Bill |
| Laboratory Reports | Clinical Lab Report; Pathology/Biopsy Report |
| Legal Documents | Durable Power of Attorney; Legal Document; |
| | Malpractice Arbitration Form; Medical Record |
| | Release Request; Organ Donor |
| Office Encounter | Blood sugar/Medication Report; Encounter; |
| Documents | Encounter Note; History and Physical Examination; |
| | Orders (Lab, X-ray, etc.); Prescription; Progress Note |
| Orders | Lab Order |
| Others | Document Not Requiring Sign-off; Other Document |
| | Requiring Sign-off; Physical Therapy/Occupational |
| | Therapy; Speech Therapy |
| Patient Documents | Correspondence From Patient; Immunization Record; Patient History |
| | Sheet and Authorization; Patient |
| | Registration Form; Previous Medical Record |
| Pharmacy Documents | Pharmacy Callback |
| Procedures | Lower GI Endoscopy; Peak Flow Meter; Pulmonary Function Test; |
| | Sigmoidoscopy; UGI Endoscopy |
| Radiology Reports | CAT Scan; Mammogram; MRI; Nuclear Medicine; |
| | Other Radiology Document; Ultrasound; X-ray |

The user opens the attached document by selecting the hyperlink associated with the selected document. Examples of the file formats for attached documents include, but are not limited to ACSII text (.txt), rich text format (.rtf), tag image file format (.tif), TX Words format (.txw), Windows sound file (.wav), Joint Photographics Experts Group image file (jpeg, .jpg), and the like.

As mentioned above, the patient chart 500 comprises the account activity section, as illustrated in FIG. 5. Examples of the account activity subsection list include, but are not limited to unallocated amounts, ledger, balance due, and billing notes, and the like, associated with the patient.

FIG. 19 illustrates one embodiment of an unallocated amounts screen 1900 used by the data viewer 200 for unallocated amounts and account details associated with the patient. In an embodiment, the unallocated amounts screen 1900 comprises a voucher date, payment type, status (paid, etc.), remaining balance, references, batch date, created date, the name of the person who created the record, and the like.

FIG. 20 illustrates one embodiment of a ledger screen 2000 used by the data viewer 200 comprising a list of the fee tickets associated with the patient. In an embodiment, the ledger screen 2000 further comprises service date, provider, referring provider, office location, charges, payments, adjustments, balances, and the like, associated with each fee ticket.

FIG. 21 illustrates one embodiment of a balance due screen 2100 used by the data viewer 200 for balances due associated with the patient. The balance due screen 2100, in an embodiment, shows the aging of the balances due grouped by patient responsibility, insurance responsibility, and the like.

FIG. 22 illustrates one embodiment of a billing notes screen 2200 used by the data viewer 200 for billing notes associated with the patient. The billing notes screen 2200, in an embodiment, comprises the notes related to billings grouped by collections, billing, miscellaneous, and the like.

As mentioned above, the patient chart 500 comprises the flowsheets section. Referring to FIG. 5, the flowsheets subsection list for the chart 500 comprises vital statistics, lab results, immunizations, and the like associated with the patient. Flowsheets are charting tools for reviewing collected patient data in digital format through clinical measures. The flowsheets section can comprise any captured data associated with the patient. The flowsheet list varies for each chart depending on the information available for the specific chart. FIG. 23 illustrates one embodiment of a vital statistics screen 2300 used by the data viewer 200. In an embodiment, the data viewer 200 displays flowsheets in a Microsoft Excel viewer application.

In addition to comprising the facesheet section, the chart documents section, the account activity section and the flowsheets section, the chart 500 comprises a help icon. Selecting help opens the default web browser on the user computer and displays navigation buttons, a navigation pane, and a topic pane. FIG. 24 illustrates one embodiment of a help screen 2400 used by the data viewer 200. The help screen 2400 comprises, in an embodiment, a contents selection, an index selection, a search selection, a navigation pane and a topic pane. In an embodiment, the contents selection comprises a hierarchical list of the help categories and topics. The index selection comprises an alphabetical list of keywords and the search selection comprises a list of the words in the topics, according to an embodiment of the invention.

FIG. 25 is a flow diagram 2500 illustrating one embodiment of user operations of the data viewer 200. In block 2510, the user opens the charts folder 400 and in block 2512, the user selects a patient chart from the chart 500 for viewing. In an embodiment, the data viewer 200 creates new HTML files derived from the XML versions of the documents stored in the database 202 and associated with the selected patient chart.

The user has the option of opening a document from the facesheet section in block 2514, the chart documents section in block 2516, the account activity section in block 2518, the flowsheets section in block 2520, the help section in block 2522, or print in block 2534. In an embodiment, the user can print at least a portion or the entire patient medical record in block 2534.

If the user selects help in block 2522, the user follows the help screen 2400 as described above.

Once the user selects a document to open from blocks 2514, 2516, 2518, 2520, the process 2500 moves to block 2524.

In block 2524, the data viewer 200 displays the selected HTML document according to an embodiment. In another embodiment, in block 2524, the data viewer 200 creates a new HTML file derived from the XML version of the selected document stored in the database 202. The user views the HTML version of the document on the display using the web browser associated with the user computer. In an embodiment, the user computer comprises a computer, a personal digital assistant, a blackberry, a cell phone, or the like. The web browser, in an embodiment, comprises any software application that enables the user to display text, images, and other information, such as, for example, Microsoft Internet Explorer, Mozilla Firefox, Apple Safari, Netscape, Opera, and the like.

If applicable, the user can open an attached document associated with the user's selection in block 2526.

The user can print at least a portion or the entire selected document or attachment in block 2528, and in block 2528 the user closes the selected document and/or the attachment.

The user can return to blocks 2514, 2516, 2518, 2520 to select another document associated with the patient. The user can return to block 2534 to print all or apportion of the patient's medical record stored in the database 202. Further, the user can return to block 2512 to select another patient chart 500 from the chart folder 400, or the user can exit the data viewer 200 in block 2532.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions, and changes in the form of the methods and systems described herein may be made without departing from the spirit of the inventions. The accompanying claims and their equivalents are intended to cover such forms or modifications as would fall within the scope and spirit of the inventions.

What is claimed is:

1. A data viewer comprising:
a plurality of electronic patient medical records associated with a medical practice, wherein the electronic patient medical records are stored in a first format, and wherein the plurality of electronic patient medical records comprise at least two medical records from two different patients;
a transform program to transform the plurality of electronic patient medical records associated with the medical practice from the first format into a second format, wherein the second format is a hierarchical XML format; and
a portable storage medium configured to store the plurality of electronic patient medical records in the second format.

2. The data viewer of claim 1, further comprising a transform program to transform the plurality of electronic patient medical records from the second format into a third format, wherein the third format is an HTML file format viewable on a browser.

3. The data viewer of claim 2, wherein the browser is Microsoft Internet Explorer.

4. The data viewer of claim 1, wherein the medical practice comprises a plurality of medical practice groups.

5. The data viewer of claim 1, wherein the data viewer is used to migrate the medical records associated with the medical practice from a first dynamic medical practice management system to a second dynamic medical practice management system.

6. The data viewer of claim 1, wherein the data viewer causes the plurality of electronic patient medical records stored in the second format to expire.

7. The data viewer of claim 1, wherein the data viewer permits a user to access multiple patients' medical records.

8. A method of viewing medical records associated with a medical practice, the method comprising:
transforming a plurality of electronic patient medical records associated with a medical practice from a first format into a second format, wherein the second format is a hierarchical XML format, and wherein the plurality of patient medical records comprise patient medical records from at least two different patients; and
storing the plurality of electronic patient medical records in the second format on a portable storage medium.

9. The method of claim 8, further comprising:
transforming the plurality of electronic patient medical records from the second format into a third format, wherein the third format is an HTML format viewable on a browser; and
displaying the electronic patient medical records in the third format.

10. The method of claim 9, wherein the browser is Microsoft Internet Explorer.

11. The method of claim 9, wherein the browser resides on a user computer.

12. The method of claim 11, wherein the user computer is a computer, a personal digital assistant, or a cell phone.

13. The method of claim 9, further comprising printing at least a portion of the displayed patient medical records.

14. The method of claim 9, further comprising displaying an attachment associated with one of the displayed patient medical records.

15. The method of claim 14, wherein the attachment is an ACSII text format file (.txt), a rich text format file (.rtf), a tag image file format (.tif), a TX Words format file (.txw), a Windows sound file (.wav), or a Joint Photographics Experts Group image file (jpeg, .jpg).

16. A computer program residing on computer readable media and invocable on a computer system, the computer program comprising:
computer code configured to transform a plurality of electronic patient medical records associated with a medical practice from a first format into a second format, wherein the second format is a hierarchical XML format, and wherein the plurality of electronic patient medical records comprise patient medical records from at least two different patients; and
computer code configured to store the plurality of electronic patient medical records in the second format on a portable storage medium.

17. The computer program of claim 16, further comprising:
computer code configured to transform the plurality of electronic patient medical records from the second format into a third format, wherein the third file format is an HTML format viewable on a browser; and
computer code configured to display the electronic patient medical records in the third format.

18. The computer program of claim 17, wherein the browser is Microsoft Internet Explorer.

19. The computer program of claim 17, further comprising computer code configured to print at least a portion of the displayed patient medical records.

20. The computer program of claim 16, further comprising computer code configured to cause the plurality of electronic patient medical records stored in the second format to expire.
